(19) United States
(12) Patent Application Publication
(10) Pub. No.: US 2003/0115736 A1
(43) Pub. Date: Jun. 26, 2003

(54) Method for stocking tool magazines of a device for machining workpieces

(75) Inventors: Artur Kurz, Wendlingen (DE); Wolfgang Liebrich, Hattenhofen (DE)

Correspondence Address: GUDRUN E. HUCKETT, LONSSTR. 53, WUPPERTAL, 42289, DE

(73) Assignee: Gebr. Heller Maschinenfabrik GmbH, Nurtingen (DE)

(21) Appl. No.: 10/065,021

(22) Filed: Sep. 11, 2002

(30) Foreign Application Priority Data
Sep. 11, 2001 (DE) 101 44 605.5

(51) Int. Cl. B23P 13/04

(52) U.S. Cl. 29/558

(57) ABSTRACT

In a method for stocking tool magazines of a device for machining workpieces, the device having at least a first spindle and a second spindle configured to be independently movable relative to one another at least in one axis, wherein the first and second spindles have correlated therewith at least a first tool magazine and a second tool magazine, respectively, workpiece machining is continued by the second spindle during stocking of the first tool magazine, and workpiece machining is continued by the first spindle during stocking of the second tool magazine. Alternatively, stocking the first and second tool magazines can be carried out simultaneously.

### BACKGROUND OF INVENTION

1. Field of the Invention

The invention relates to a method for stocking tool magazines of a device for machining workpieces, comprising at least two spindles movable independently from one another at least in one axis and having correlated therewith at least one tool magazine, respectively.

2. Description of the Related Art

Machine tools are known which have two spindles (DE 198 51 264) and comprise an annular main tool magazine and two intermediate tool storage devices correlated with one of the spindles, respectively. In order to accelerate the tool exchange, tools are moved from the main tool magazine into the intermediate magazines during the main machining operation. When a tool exchange is carried out, the tools positioned on the main spindles are deposited in the intermediate storage device and new tools are picked up by a pick-up method from the intermediate storage device. As a result of the minimal capacity of intermediate storage device of approximately two tools per spindle, machining is not possible during stocking of the main tool magazine.

Moreover, a two-spindle machine tool is known (DE 195 03 482) whose two spindles are movable independently from one another and with which alternatingly a workpiece positioned on a workpiece table can be machined. While one spindle works on the workpiece, a new tool is positioned on the other spindle. Both spindles access a common chain-shaped tool magazine. During stocking of the tool magazine it is not possible to perform work with the machine tool.

In another known machine tool (DE 199 20 224) two spindles are movable independently from one another. Each spindle has correlated therewith a separate tool magazine from which the tools are removed by a pick-up process. Machining of workpieces is not provided for during magazine stocking.

Moreover, single-spindle machining centers are known which have a tool access port into which tools can be inserted during the course of a machining program. A tool exchange device enables the transport of tools from the tool access port to the respective storage position particularly at the time when it is not needed for the transport of the tool to the main spindle.

### SUMMARY OF INVENTION

It is an object of the present invention to configure the method of the aforementioned kind such that the production capacity of the machine tool can be increased.

In accordance with the present invention, this is achieved in that, according to a first embodiment, workpiece machining by the second spindle is continued during stocking of the first tool magazine and workpiece machining is continued by the first spindle during stocking of the second tool magazine

In accordance with the present invention, this is achieved in that, according to a second embodiment, the two magazines are simultaneously stocked.

According to the first embodiment of the method of the present invention, the two tool magazines are sequentially stocked. During the stocking of the first tool magazine, the second spindle, which is correlated with the second tool magazine, can continue to perform machining steps on the workpiece. When the first tool magazine has been stocked, stocking of the second tool magazine takes place. During this stocking process, the first spindle can continue to perform machining steps on the workpiece. By continuing machining during the stocking process, the production capacity of the machine tool is increased without requiring the use of additional machine components. The term stocking refers to removal of the tools from the magazine as well as the insertion of tools into the tool magazine.

According to the second embodiment of the method of the present invention, both tool magazines are loaded at the same time so that the production capacity of the machine tool is increased also in this way

### BRIEF DESCRIPTION OF DRAWINGS

In the drawing:

FIG. 1 shows a front view of the device according to the invention embodied as a two-spindle machining center.

### DETAILED DESCRIPTION

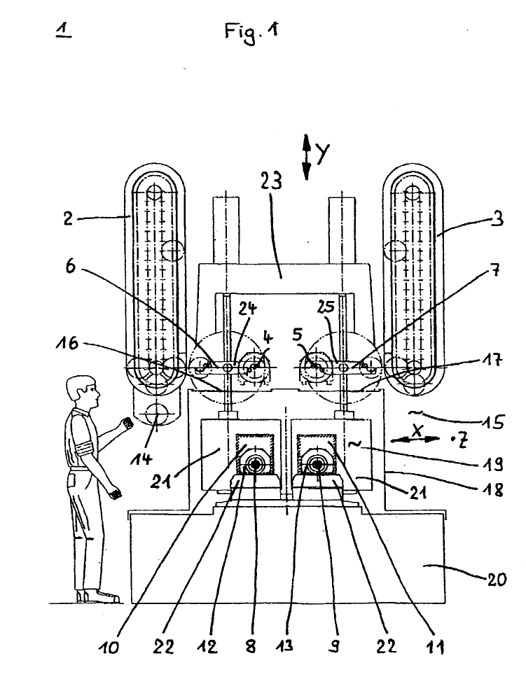

FIG. 1 shows in the front view that the device 1 is embodied as a two-spindle machining center. It comprises the machine frame 20 with the machine stand 23 on which two carriages 21 are movable in the direction Y. The two carriages 21 support spindle heads 12, 13 which are movable independently from one another and support the tool 8, 9, respectively. The spindle heads 12, 13 are embodied as pinole spindles and are movable in the direction Z. The spindle axes are positioned horizontally. The horizontal position of the spindle axes and thus also of the tool axes has the advantage that a stable guiding of the carriage 21 is achieved and that the workpiece loading can take place from above.

The machine stand 23 is movable on the machine frame 20 along guides (not illustrated) in the direction X. In the area in front of the spindle heads 12, 13, the machine frame 20 is provided with a workpiece support 22, respectively, on which the workpieces 10, 11 to be machined can be clamped directly. The machine stand 23 is movable in the direction X perpendicularly to the directions Z and Y on the machine frame 20 relative to the workpiece 10, 11.

A tool magazine 2, 3, having a configuration known in the art, is correlated with the spindles of the spindle heads 12, 13, respectively, and positioned in a vertical plane. Each tool magazine 2, 3 is of an endless circulating configuration and contains the corresponding tools 8, 9. For performing a tool exchange, the corresponding spindle head 12, 13 is moved in the directions Y and Z to a corresponding tool changer 6, 7 and the tool 8, 9, which has just been used, is exchanged for a new tool from the tool magazine 2, 3 by performing a pivot movement about 180°. The corresponding tool is transferred to the spindle head 12, 13 by means of the tool changer 6, 7 which comprises a double gripping device 24, 25 positioned so as to be pivotable about an axis positioned in the direction Z. The configuration and function of such a tool changer 6, 7 is well known in the art and is therefore not described in detail in this context.

The tool changers 6, 7 enable very short clamping-to-clamping times because the time for exchanging the tools falls within the main machining time of the machine tool as a result of moving the tool magazines 2, 3. Advantageously, the double gripping device 24, 25 of the tool changer 6, 7 does not pick up the tool 8, 9 directly from the tool magazines 2, 3 but from a ready position 4, 5.

The two spindle heads 12, 13 which are independently movable relative to one another in the directions Y and Z and the tools 8, 9 clamped thereon machine during normal operation identical workpieces 10, 11, respectively. The two tool magazines 2, 3 store identical tool sets. The tools 8, 9 are exchanged by the tool gripping devices 24, 25, as is known in the art. When the end of the service life of the tool sets is reached, first the spindle head 12, for example, moves into the direction Y into the ready or tool changing position 4. Prior to this, a protective flap 16 of a protective cover 18 must be opened which cover 18 encloses the working chamber 19 of the machining center 1. When the spindle head 12 has been moved into the tool changing position 4, the tool 8 is gripped by the double gripping device 24 (tool changer 6) which is pivoted about an axis positioned in the direction Z and transfers this tool to the tool magazine 2. For protecting the spindle head 12 against soiling, a spindle closure flap (not illustrated) is now moved into position and returned by the carriage 21 in the direction Y to the working chamber 19. The protective flap 16 can be closed subsequently. The spindle head 12 either performs the sequence of steps for machining the workpiece 10 according to a computer program without machining the workpiece 10 or the spindle head 12 is deactivated (stopped).

The machine operator can now easily and comfortably stock the tool magazine 2 in the stocking position 14 with the required tools. During the stocking process, the tool 9 of the spindle 12 of the spindle head 13 machines the workpiece 11. In this stocking phase, the machining center 1 operates with half its production capacity.

After completion of stocking, a new tool can be positioned on the spindle head 12 by means of the tool changer 6 after it has been returned upwardly into the tool changing position 4. After exchanging the tool, the spindle head 12 moves downwardly and begins machining of the workpiece 10.

Subsequently, the tool magazine 3 can be stocked in an analogous fashion. After opening of the protective flap 17 of the protective cover 18, the spindle head 13 is moved by means of the carriage 21 in the upward direction into the ready or tool changing position 5. The tool 9 which is clamped in the spindle head 13 is received by the tool changer 7 embodied as a double gripping device and is deposited, as is known in the art, in the tool magazine 3. For protecting the spindle head 13 or its spindle against soiling, a spindle closure is put in place by means of the tool changer 7. The spindle head 13 can now be moved downwardly into the working chamber 19 in the direction Y and the protective flap 17 can be closed. This spindle head 13 then performs either the steps for machining the workpiece 11 according to a programmed sequence without machining the workpiece 11 or it is deactivated (stopped). The machine operator can now stock the tool magazine 3 in the stocking position 15. During the stocking process, the spindle head 12 continues to machine the workpiece 10 by means of the tool 8. In this situation, the machining center 1 also operates at half its production capacity. After completion of the stocking process, the tool magazine 3 is returned into its initial position and the spindle head 13 is moved upwardly into the tool changing position 7. By means of the tool changer 7 the desired tool 9 from the newly stocked tool magazine 3 can now be changed into the spindle head 13. The spindle head 13 can then be returned into the working chamber for machining the workpieces 11. The machining center 1 operates again at full production capacity, i.e., in normal operation.

The machine operator during stocking of the tool magazines 2, 3 is separated from the working chamber 19 by the protective cover 18 so that the machine operator is not endangered during the stocking process by the machining processes occurring at the same time in the working chamber 19.

By maintaining the production during stocking of the respective tool magazines 2, 3, the production capacity of the machining center 1 is increased without this requiring additional machine components. The term stocking is to be understood to include removal of the tools from the magazine as well as the insertion of tools into the magazine. During stocking of the tool magazines 2, 3, production capacities are achieved which correspond to 50% of the production capacity during normal operation. This is a significant improvement in comparison to known methods, in which a machining of the workpieces 10, 11 does not occur during stocking of the tool magazines.

The increase of the production capacity over the entire machining process depends quantitatively on different factors, for example, the duration or the intervals of the magazine stocking process. The type of workpiece loading also affects the increase of production capacity. When the workpieces 10, 11 are automatically loaded, the machine operator can perform the process of tool magazine stocking quickly so that the continuation of normal operation of the machining center 1 is possible quickly. When the workpieces 10, 11 are manually loaded, this requires an interruption of the tool stocking operation as soon as a machined workpiece 10, 11 is removed and a new workpiece to be machined is clamped. This prolongs the stocking operation, and the point in time for taking up normal operation of the machining center 1, i.e., machining by means of both spindle heads 12, 13, is delayed. The increase of production capacity is then lower in comparison to automatic workpiece loading; however, in comparison to conventional methods, in which during tool magazine stocking a processing of the workpieces is not possible, this still represents a significant production capacity increase.

With the described method, the production capacity of the machining center 1 can be increased with only minimally higher investment costs. For performing the described method, only one machine operator is required.

However, it is also possible to load both tool magazines 2, 3 simultaneously. In this case, a second machine operator is required.

By means of the spindle heads 12, 13 and the tools 8, 9, identical workpieces 10, 11 can be machined with parallel and identical working sequences. However, it is also possible to machine a workpiece with both spindles alternatingly wherein each tool magazine 2, 3 contains an identical set of tools. In this situation, during the stocking process of one of the tool magazines the production process of the machine tool can be continued.

Finally, it is also possible to machine a workpiece simultaneously with both spindles. In this situation, the tool magazines 2, 3 are provided with identical tool sets.

While specific embodiments of the invention have been shown and described in detail to illustrate the inventive principles, it will be understood that the invention may be embodied otherwise without departing from such principles.

What is claimed is:

1. A method for stocking tool magazines of a device for machining workpieces, the device comprising at least a first spindle (12) and a second spindle (13) configured to be independently movable relative to one another at least in one axis, wherein the first and second spindles (12, 13) have correlated therewith at least a first tool magazine (2) and a second tool magazine (3), respectively, comprising the steps of:
continuing workpiece machining by the second spindle (13) during stocking of the first tool magazine (2); and
continuing workpiece machining by the first spindle (12) during stocking of the second tool magazine (3).

2. The method according to claim 1, wherein stocking of the first and second tool magazines (2, 3) is carried out by a single machine operator.

3. The method according to claim 3, comprising the step of moving the first and second tool magazines (2, 3) into a stocking position (14, 15) for stocking.

4. The method according to claim 1, wherein workpiece machining by the first and second spindles (12, 13) is carried out parallel and identically on identical workpieces (10, 11).

5. The method according to claim 1, wherein workpiece machining is carried out alternatingly by the first and second spindles (12, 13) on one workpiece (10).

6. The method according to claim 5, wherein the first and second tool magazines (2, 3) correlated with the first and second spindles (12, 13) contain identical sets of tools.

7. The method according to claim 1, wherein workpiece machining is carried out simultaneously by the first and second spindles (12, 13) on one workpiece (10).

8. The method according to claim 7, wherein the first and second tool magazines (2, 3) correlated with the first and second spindles (12, 13) contain identical sets of tools.

9. A method for stocking tool magazines of a device for machining workpieces, the device comprising at least a first spindle (12) and a second spindle (13) configured to be independently movable relative to one another at least in one axis, wherein the first and second spindles (12, 13) have correlated therewith at least a first tool magazine (2) and a second tool magazine (3), respectively, comprising the step of stocking the first and second tool magazines (2, 3) simultaneously.

10. The method according to claim 9, wherein stocking of the first tool magazine (2) is carried out by a first machine operator and stocking of the second tool magazine (3) is carried out by a second machine operator.

11. The method according to claim 9, comprising the step of moving the first and second tool magazines (2, 3) into a stocking position (14, 15) for stocking.

12. The method according to claim 9, wherein workpiece machining by the first and second spindles (12, 13) is carried out parallel and identically on identical workpieces (10, 11).

13. The method according to claim 9, wherein workpiece machining is carried out alternatingly by the first and second spindles (12, 13) on one workpiece (10).

14. The methods according to claim 13, wherein the first and second tool magazines (2, 3) correlated with the first and second spindles (12, 13) contain identical sets of tools.

15. The method according to claim 9, wherein workpiece machining is carried out simultaneously by the first and second spindles (12, 13) on one workpiece (10).

16. The method according to claim 15, wherein the first and second tool magazines (2, 3) correlated with the first and second spindles (12, 13) contain identical sets of tools.
